(19) United States
(12) Patent Application Publication
(10) Pub. No.: US 2011/0138968 A1
(43) Pub. Date: Jun. 16, 2011

(54) Bump-N-Rip: Methods and apparatus relating to roof shingle tear off

(76) Inventor: Kevin J. Kubly, Edgewood, IA (US)

(21) Appl. No.: 12/803,904

(22) Filed: Jul. 9, 2010

Related U.S. Application Data
(60) Provisional application No. 61/226,370, filed on Jul. 17, 2009.

(51) Int. Cl. E04D 15/02; B23P 11/00

(52) U.S. Cl. 81/45; 29/426.5

(57) ABSTRACT

A tool and method is provided for removing roof shingles. The tool has a triangular frame, and may include multiple triangles. In some embodiments, two or more bearings attach to the frame, and two or more wheels attach to the bearings. A blade may be attached to the frame at an attachment surface. The blade may be replaceable. The blade may be serrated. In some embodiments a handle may be attached at the backplate. The tool can be used sitting or standing up slope from the tool, by pushing with the body against the handle to slide the blade under shingles or other roofing material, pushing the handle down to lift roofing material.

### RELATED APPLICATIONS

The present application claims priority to U.S. Provisional Application 61/226,370 filed on Jul. 17, 2009, for inventor Kevin Joel Kubly, titled “ROOF SHINGLE TEAR OFF TOOL” which is hereby incorporated by reference.

### FIELD

Various embodiments are directed to methods and apparatus for roof shingle removal.

### BACKGROUND

Removing shingles from a roof is strenuous, physical, and hazardous work. Existing tools are either much like serrated shovels or pitchforks requiring physical force applied to shove them under the shingles and pull or lever upward to remove them; or they are motorized, dramatically increasing the weight of the tools and requiring cords, hoses, or other means of powering.

There is a need for a shingle removal tool that reduces the force required without greatly increasing the weight or adding cords or other power sources to the hazardous environment on a roof. There is also a need to reduce the hazard of roof removal, for example, on steeper roofs.

### BRIEF DESCRIPTION OF THE FIGURES

FIG. 1 illustrates a frame of a shingle removal tool, with a front view, a side view and a bottom view.

FIG. 2 illustrates an individual triangle used in the frame.

FIG. 3 illustrates an individual triangle with a bracket for attaching wheels.

FIG. 4 illustrates a blade plate that attaches to the front of a triangle.

FIG. 5 illustrates a backplate with slots for the individual triangles, and a hole for the handle.

FIG. 6 illustrates a blade with slots for attaching to the blade plate.

FIG. 7 illustrates a catch.

FIG. 8 illustrates a name plate that can be attached for adding a name, logo, part number, or other pertinent information.

FIG. 9 illustrates a handle which can be shortened by removing one segment of an elongated member.

### SUMMARY

A tool and method is provided for removing roof shingles. The tool has a triangular frame, and may include multiple triangles. In some embodiments, the triangles include a first elongate member, a second elongate member attached to the first member, a third elongate member attached to the first and second members, the third member less than half as long as the first member and less than half as long as the second member. An attachment surface configured to receive a blade may be included, the attachment surface being proximate to an attachment of the first elongate members and the second elongate members near the acute angle of the triangles. Some embodiments may include a backplate connecting said third members of said triangles.

In some embodiments, two or more bearings attach to the frame, and two or more wheels attach to the bearings. A plurality of the triangles may have a bracket formed on the second member near to the third member, the bracket having a hole and the bearings are attached to the frame through the hole. A blade may be attached to the frame at said attachment surface. The blade may be replaceable. The blade may be serrated. The blade may be horizontal and may be attached to the attachment surface at an angle of approximately 140 degrees. The blade height may be adjustable. In some embodiments a handle may be attached at said backplate. Said handle may be of adjustable length. Said tool can be used sitting or standing up slope from the tool, by pushing with the body against said handle to slide the blade under shingles or other roofing material, pushing the handle down to lift roofing material, and repeating.

A means for removing roofing material. One embodiment may include a triangle shaped head with a thin front edge and a wider back edge. It may also include a means of pushing said head forward and downward and a means of reducing the friction when pushing forward.

### DESCRIPTION

A shingle removal tool may reduce the work required to remove shingles without dramatically increasing the weight of the tool or adding cords or other power sources, such as, for example, in the hazardous environment on a roof. It may also help reduce the hazard of roof removal, for example on steeper roofs.

A wedge shape is made up of multiple triangles connected by a backplate at the back and a blade attachment plate at the front which allows for a blade to be attached at the front, smallest angle of the triangle. In some embodiments, a handle can be attached at the backplate. In some embodiments, wheels can be attached on the bottom of the edge at brackets that are on the lower side of some of the triangles.

The blade slides under the shingles when pushed forward. Because it is serrated, it is not blocked by nails. The wheels make this movement easier. When the blade and part of the triangular frame are under the shingles, moving the far end of the handle down lifts the shingles and nails from the roof. The wheels can be used as a fulcrum to create leverage and reduce the force required to lift the shingles and nails off the roof. The shingles and nails are therefore detached more easily. Using less force on a slanted surface helps the user maintain balance and reduces the risk of falling. On steeper roofs, or in any other situation that warrants it, the handle can be shortened to allow the user to operate from a sitting position. The position of the blade along the front of the wedge can also be adjusted up or down. This changes the height of the handle and the angle of the handle in regard to the surface of the roof. This roof removal tool can be used moving from the peak of the roof down, rather than across the roof, which applies gravity to the users advantage rather than working against it.

The advantages include a reduction of the force required to lift the shingle and nails from the roof surface and adjustability of the blade and handle. The reduction of force required improves safety and allows the work to be done with less time and effort. The tool can be used by pushing forward with the body rather than the hands. This reduces the work even more. Three men can typically tear off 10-12 squares per hour and two layers of shingles can be torn off as quickly as one. Back and elbow pain normally associated with shingle tear off are reduced or even eliminated. The adjustability can increase the comfort and safety of roof removal.

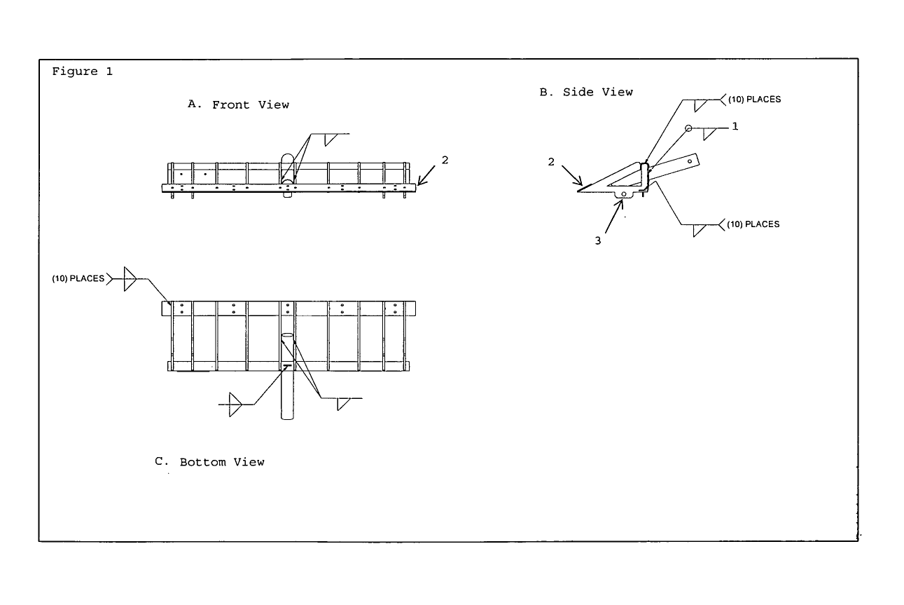

FIG. 1 illustrates the frame which includes triangles, a back plate, a place to attach a handle, and a blade plate where a blade can be attached.

FIG. 1A is a front view facing into the blade plate and going toward the back plate. The blade plate is connected near the acute angle of the triangles and shown at part 2.

FIG. 1B is a side view showing the triangular shape of the frame, the brackets for attaching wheels and the approximate angle at which the handle protrudes. The handle attaches at part 1, the blade plate is at part 2, and the bracket for attaching a wheel is at part 3. The bracket extends below the lower side of the triangle placing the wheels below the triangle and increasing leverage for lifting shingles and nails from the roof. The location of a handle in the frame is also shown in FIGS. 1A, 1B, and 1C.

FIG. 1C is a top view looking down on the frame. This embodiment has 10 triangles, four of which have brackets. Different embodiments could have different numbers of triangles.

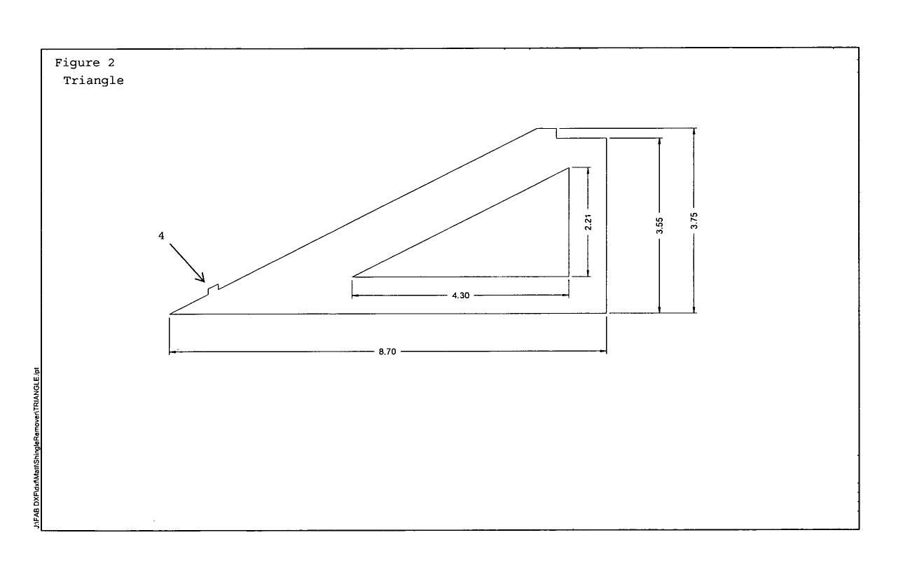

FIG. 2 illustrates an individual triangle used in the frame. The approximate dimensions for this embodiment are given in inches. Different embodiments can have different dimensions. Part 4 shows the connecting point for the blade plate, and a notch is seen at the top right of the triangle where the back plate is connected.

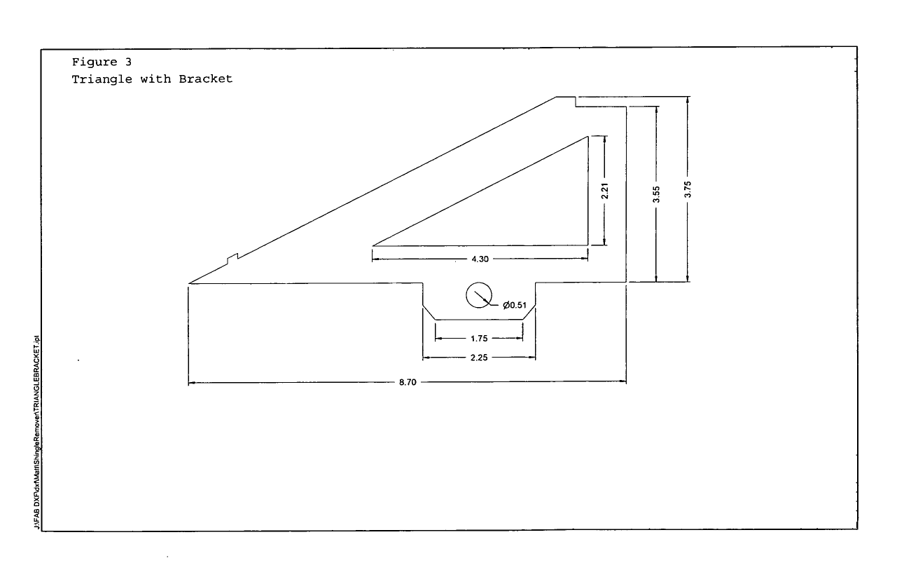

FIG. 3 illustrates an individual triangle with a bracket for attaching wheels. Approximate dimensions are given in inches for this embodiment. Different embodiments could have different dimensions. This bracket extends below the lower side of the triangle and includes a circular hole for attaching a wheel axel.

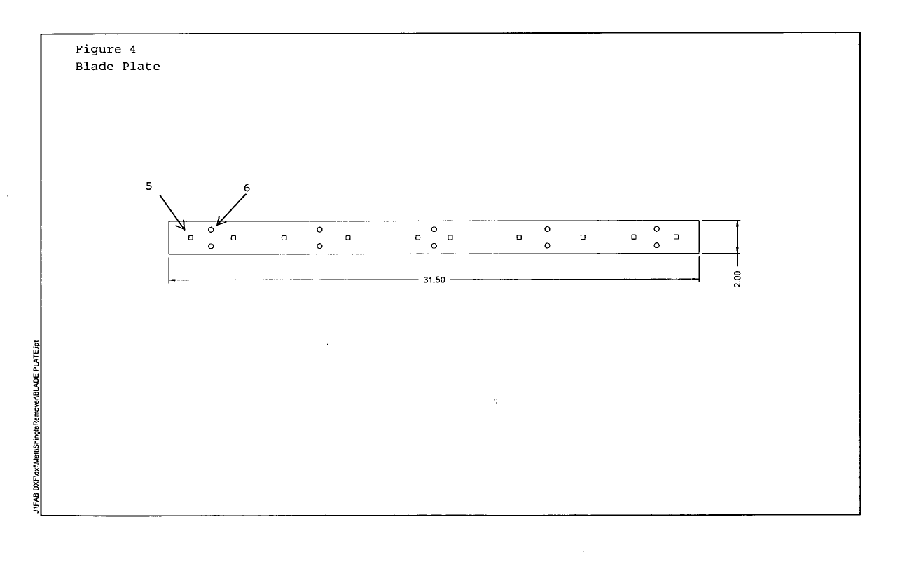

FIG. 4 illustrates a front view of a blade plate that attaches to the front of each triangle. It connects the triangles and provides a means to attach and detach the blade. Part 5 is the hole for connecting to the frame at FIG. 2 part 4. Part 6 shows the holes for attaching the blade. The number of holes in this embodiment corresponds with the ten triangles, but different embodiments can have a different number of corresponding holes. Dimensions for this embodiment are given in inches. Other embodiments can have different dimensions.

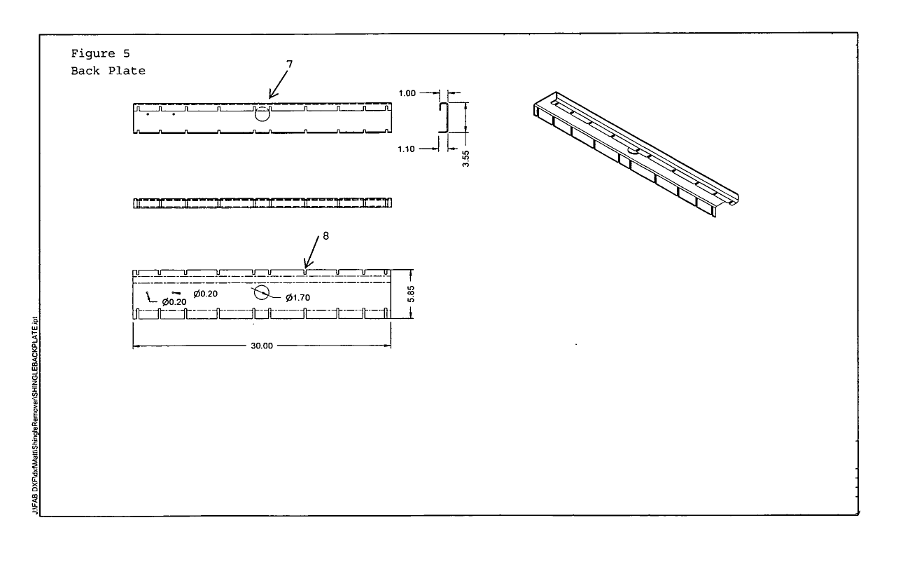

FIG. 5 illustrates a backplate with slots for the individual triangles, and a hole for the handle. Part 7 is where it can be optionally secured to several different handles and part 8 shows the slots for attaching the triangles.

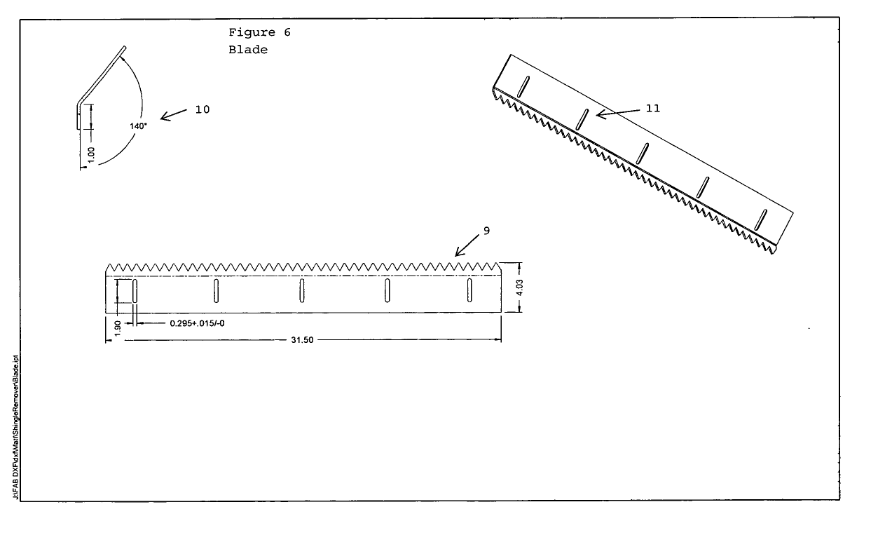

FIG. 6 illustrates a blade with slots for attaching to the blade plate. Dimensions are given in inches for the preferred embodiment, but other embodiments can have different dimensions. Part 9 shows the serrated edge of this embodiment. Part 10 shows the angle between the serrated edge and the attachment to the frame at approximately 140 degrees. Part 11 shows the slots for attaching to the blade plate. The slots are long enough to allow the blade to be attached at different heights at FIG. 4 part 6.

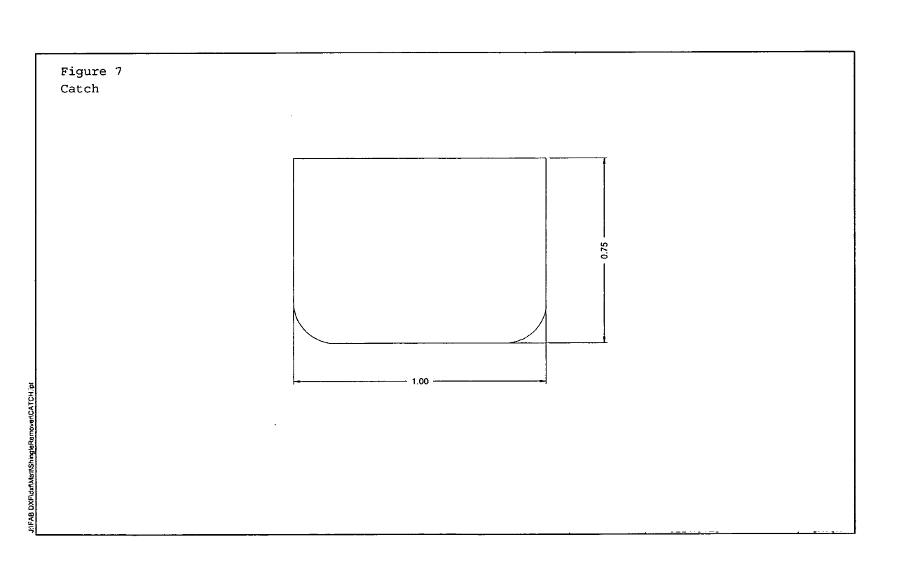

FIG. 7 shows a catch which in this embodiment is attached to the bottom of the frame to catch nails and other falling pieces. Dimensions are given in inches for the preferred embodiment, but other embodiments can have different dimensions.

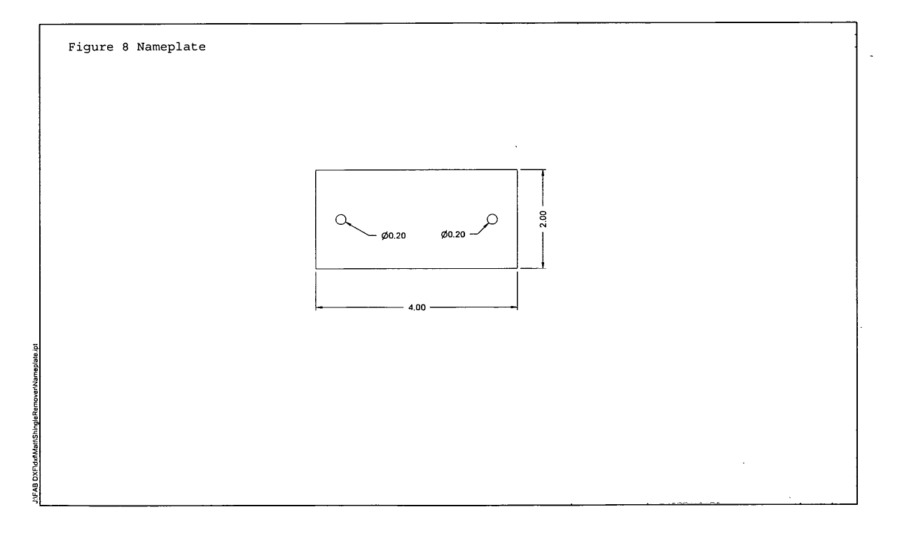

FIG. 8 illustrates a name plate that can be attached for adding a name, logo, part number, or other pertinent information. Dimensions are shown for the preferred embodiment, but other embodiments can have different dimensions.

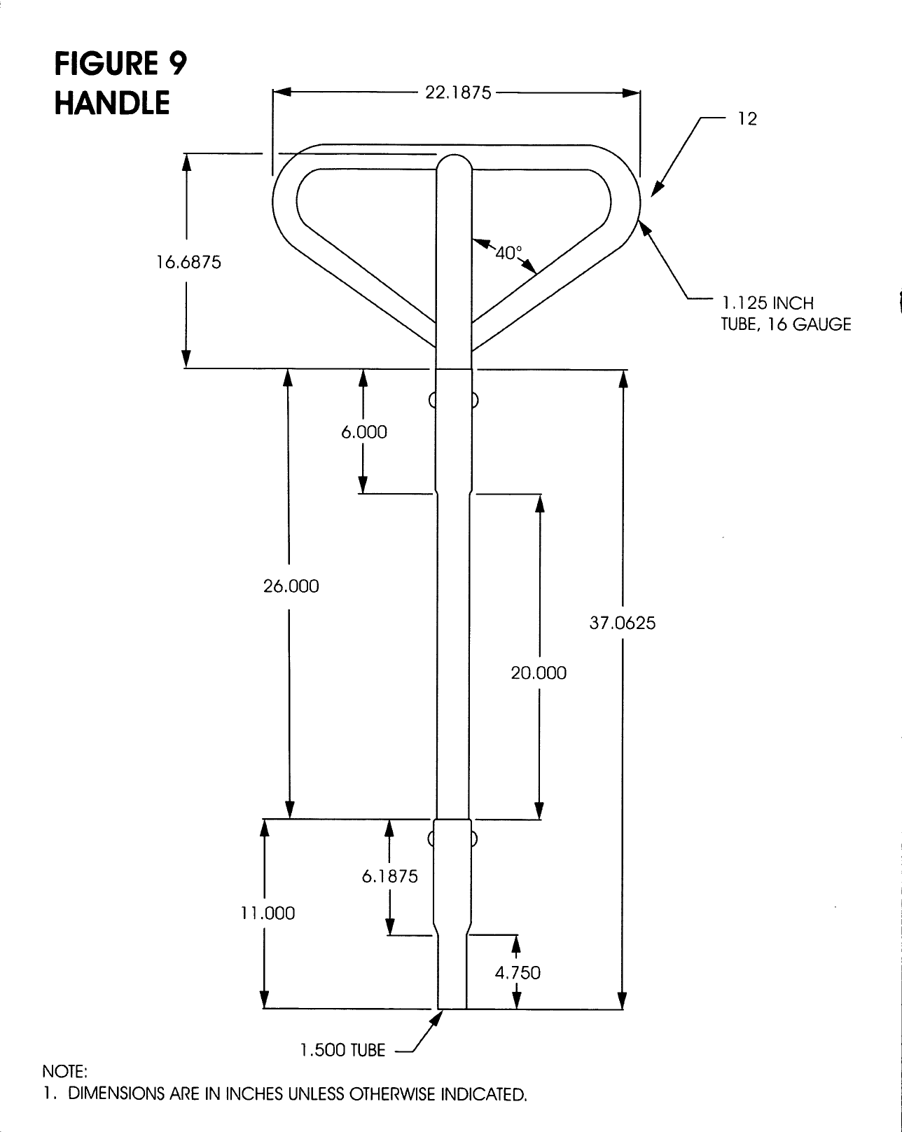

FIG. 9 shows an adjustable length handle. In some embodiments, the handle has a 20 inch section, part 13, which can be removed to shorten the handle and allow the tool to be used in a sitting position. This is especially advantageous on steeper roofs. Part 12 shows a two handed grip. This embodiment reduces work and back strain. The user stays in an upright position and pushes forward then down with both hands.

In this embodiment the frame and triangles are made of flat metal. Other embodiments could be made from tubing, or other appropriate elongated shapes and from any suitably strong and rigid material. Acceptable materials include, without limitation, mild steel, carbon steel, alloy steel, tungsten, silicon carbide, titanium, and fiberglass.

One embodiment shows a two hand grip, but different embodiments can have other grips, or no grip. Dimensions are shown, but other embodiments can have different dimensions.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A tool for removing roof shingles comprising:
a triangular frame comprising:
multiple triangles, each comprising:
a first elongate member;
a second elongate member attached to said first member
a third elongate member attached to said first and second members, said third member less than half as long as said first member and less than half as long as said second member,
an attachment surface configured to receive a blade, said attachment surface being proximate to an attachment of said first elongate members and said second elongate members near the acute angle of the triangles;
a backplate connecting said third members of said triangles.

2. The tool of claim 1, further comprising:
two or more bearings attached to said frame,
two or more wheels attached to said bearings.

3. The tool of claim 2 wherein a plurality of said triangles have a bracket formed on the second member near to the third member, said bracket having a hole and said bearings are attached to said frame through said hole.

4. The tool of claim 1, further comprising:
a blade attached to the frame at said attachment surface.

5. The tool of claim 2 further comprising:
a blade attached to the frame at said attachment surface.

6. The tool of claim 4 wherein the blade is replaceable.

7. The tool of claim 5 wherein the blade is replaceable.

8. The tool of claim 6 wherein the blade is replaceable

9. The tool of claim 4 wherein the blade is serrated.

10. The tool of claim 5 wherein the blade is serrated.

11. The tool of claim 6 wherein the blade is serrated.

12. The tool of claim 4 wherein the blade is horizontal and is attached to said attachment surface at an angle of approximately 140 degrees.

13. The tool of claim 5 wherein the blade is horizontal and is attached to said attachment surface at an angle of approximately 140 degrees.

14. The tool of claim 4 wherein the blade height is adjustable.

15. The tool of claim 5 wherein the blade height is adjustable.

16. The tool of claim 1 further comprising:
A handle attached to the frame at said backplate.

17. The tool of claim 2 further comprising:
A handle attached to the frame at said backplate.

18. The tool of claim 16 wherein the length of said handle is adjustable.

19. The tool of claim 17 wherein the length of said handle is adjustable.

20. The tool of claim 4 further comprising:
an adjustable length handle attached to the frame at said backplate.

21. The tool of claim 5 further comprising:
an adjustable length handle attached to the frame at said backplate.

22. A method of removing roof shingles comprising:
standing or sitting up slope of a tool gripping a handle of the tool with the handle against the users body;
pushing with the users body to move a blade of the tool under the roof shingles;
pushing the handle of the tool downward to lift the roof shingles from the roof; and
repeating the standing or sitting, the pushing the blade, and the pushing the handle downward.

23. A means of removing roofing materials comprising:
A triangle shaped head with a thin front edge and a wider back edge;
A means of pushing said head forward and downward; and
A means of reducing the friction when pushing forward.
